(19) United States
(12) Patent Application Publication
(10) Pub. No.: US 2015/0149650 A1
(43) Pub. Date: May 28, 2015

(54) METHOD AND DEVICE FOR POSITIONING SESSION INITITAION PROTOCOL DIALOG

(71) Applicant: ZTE CORPORATION, Shenzhen, Guangdong Province (CN)

(72) Inventor: Jianchi Guan, Shenzhen (CN)

(21) Appl. No.: 14/411,834

(22) PCT Filed: Jun. 24, 2013
(86) PCT No.: PCT/CN2013/077801

§ 371 Date: Dec. 29, 2014

(30) Foreign Application Priority Data
Jun. 28, 2012 (CN) 201210217558.6

(51) Int. Cl. H04L 29/06

(52) U.S. Cl. CPC H04L 65/1006; H04L 65/1069
USPC 709/228

(57) ABSTRACT

The disclosure discloses a Session Initiation Protocol (SIP) dialog positioning method and a SIP dialog positioning device. The method includes that: a network element receives an in-dialog SIP message with index information, wherein the index information is used for indicating a position of a dialog at a calling party or a called party; and the network element positions the dialog according to the index information. According to the disclosure, the index information for indicating the position of the dialog at the calling party or the called party is carried by the in-dialog SIP message, and the dialog is positioned according to the index information, so that such an implementation mode is simple and high in positioning speed, and the performance of the network element is improved.

### TECHNICAL FIELD

The disclosure relates to the field of communications, including e.g., a method and device for positioning Session Initiation Protocol (SIP) dialog.

### BACKGROUND

In an IP Multimedia Subsystem (IMS), SIP is adopted as a call control protocol.

A dialog is a core concept of a SIP network defined in a Request For Comments (RFC) 3261. The dialog represents a peer-to-peer SIP relationship kept for a period of time between two User Agents (UA). The dialog makes the sequential transmission of messages between the UAs and requesting for a correct route between the two UAs easier. The dialog can be considered as a context relationship for interpreting SIP messages. In the protocol, a dialog ID includes a Call-ID, a Local-Tag, a remote Tag and the like. A core network element of the IMS needs to process a great number of SIP messages, so that after the SIP messages are received, if the dialog to which the SIP messages belong can be rapidly determined, the performance of the network element can be improved.

Usually, for a SIP response, an affair should be matched firstly, and the affair is usually associated with the dialog, so that the dialog matching of the SIP response is usually not a problem. For a SIP request, an initial request does not need dialog positioning, and dialog positioning is mainly for an in-dialog request.

At present, a common dialog positioning mode is to acquire Call-ID, From-Tag and To-Tag character strings from the SIP request for Hash location, thereby determining the dialog corresponding to the request. In the above-mentioned process, the network element needs to extract header parameter contents such as the Call-ID, a From-Tag and a To-Tag from a SIP code stream, and strings and Hash locate the above related contents, so that a dialog positioning process is more complex and lower in positioning speed.

### SUMMARY

A method and a device for positioning a SIP dialog in the disclosure, so as to at least solve the problems of complexity and low positioning speed of an implementation method for positioning a dialog corresponding to an in-dialog SIP message in a related art.

According to one aspect of the disclosure, a method for positioning SIP dialog is provided, comprises: a network element receives an in-dialog SIP message carrying index information, wherein the index information is used for indicating a position of a dialog at a calling party or a called party; and the network element positions the dialog according to the index information.

According to an embodiment of the disclosure, based on that the network element is an SIP proxy, before the network element receives the in-dialog SIP message carrying the index information, the method further comprises that: the SIP Proxy adds a first index information to an initial message received from the calling party, wherein the first index information is used for indicating the position of the current dialog at the calling party; and the SIP proxy transmits the initial message carrying the first index information to the called party.

According to an embodiment of the disclosure, after the SIP proxy transmits the initial message carrying the first index information to the called party, the method further comprises that: the SIP proxy receives a response message carrying the first index information from the called party; the SIP proxy modifies the first index information, wherein a modified first index information is used for indicating the position of the current dialog at the called party; and the SIP proxy transmits the response message carrying the modified first index information to the calling party.

According to an embodiment of the disclosure, that the network element receives the in-dialog SIP message carrying the index information comprises that: the SIP proxy receives the in-dialog SIP message carrying the modified first index information from the calling party, or receives the in-dialog SIP message carrying the first index information from the called party

According to an embodiment of the disclosure, that the network element positions the dialog according to the index information comprises that: the SIP proxy acquires the modified first index information or the first index information from the in-dialog SIP message; and the SIP proxy positions the dialog according to the modified first index information or the first index information.

According to an embodiment of the disclosure, based on that the network element is an SIP UA and is the calling party of the dialog, before the network element receives the in-dialog SIP message carrying the index information, the method further comprises that: the SIP UA transmits an initial message carrying second index information to the called party, wherein the second index information is used for indicating the position of the current dialog at the calling party.

According to an embodiment of the disclosure, the network element receives the in-dialog SIP message carrying the index information comprises that: the SIP UA receives the in-dialog SIP message carrying the second index information from the called party.

According to an embodiment of the disclosure, the network element positions the dialog according to the index information comprises that: the SIP UA acquires the second index information from the in-dialog SIP message; and the SIP UA positions the current dialog according to the second index information.

According to an embodiment of the disclosure, based on that the network element is an SIP UA and is the called party of the dialog, before the network element receives the in-dialog SIP message carrying the index information, the method further comprises that: the SIP UA receives the initial message from the calling party; and the SIP UA transmits a response message carrying third index information to the calling party, wherein the third index information is used for indicating the position of the current dialog at the called party.

According to an embodiment of the disclosure, the network element receives the in-dialog SIP message carrying the index information comprises that: the SIP UA receives the in-dialog SIP message carrying the third index information from the calling party.

According to an embodiment of the disclosure, the network element positions the dialog according to the index information comprises that: the SIP UA acquires the third index information from the in-dialog SIP message; and the SIP UA positions the current dialog according to the third index information.

According to an embodiment of the disclosure, the index information is carried by one of the following fields: Request-uri, contact, from, to, Route and Record-Route.

According to another aspect of the disclosure, a device for positioning SIP dialog is provided, which is applied to a network element and comprises: a receiving component which is configured to receive an in-dialog SIP message carrying index information, wherein the index information is used for indicating a position of a dialog at a calling party or a called party; and a positioning component, which is configured to position the dialog according to the index information.

According to a third aspect of the disclosure, a SIP proxy is provided, comprising: a first receiving component, which is configured to receive an in-dialog SIP message carrying index information, wherein the index information is used for indicating a position of a dialog at a calling party or a called party; and a positioning component, which is configured to position the dialog according to the index information.

According to an embodiment of the disclosure, the SIP proxy further comprises: an adding component, which is configured to add a first index information to an initial message received from the calling party, wherein the first index information is used for indicating the position of the current dialog at the calling party; and a first transmissing component, which is configured to transmit the initial message carrying the first index information to the called party.

According to an embodiment of the disclosure, the SIP proxy further comprises: a second receiving component, which is configured to receive a response message carrying the first index information from the called party; a modifying component, which is configured to modify the first index information, wherein a modified first index information is used for indicating the position of the current dialog at the called party; and a second transmissing component, which is configured to transmit the response message carrying the modified first index information to the calling party.

According to an embodiment of the disclosure, the first receiving component comprises: a receiving element, which is configured to receive the in-dialog SIP message carrying the modified first index information from the calling party, or receive the in-dialog SIP message carrying the first index information from the called, party.

According to an embodiment of the disclosure, the positioning component comprises: an acquiring element, which is configured to acquire the modified first index information or the first index information from the in-dialog SIP message; and a positioning element, which is configured to position the dialog according to the modified first index information or the first index information.

According to an embodiment of the disclosure, the index information is carried by one of the following fields: Route and Record-Route.

According to a fourth aspect of the disclosure, an SIP UA is provided, comprising: a first receiving component, which is configured to receive an in-dialog SIP message carrying index information, wherein the index information is used for indicating a position of a dialog at a calling party or a called party; and a positioning component, which is configured to position the dialog according to the index information.

According to an embodiment of the disclosure, the SIP UA further comprises: a first transmissing component, which is configured to, based on that the SIP UA is the calling party of the dialog, transmit an initial message carrying second index information to the called party, wherein the second index information is used for indicating the position of the current dialog at the calling party.

According to an embodiment of the disclosure, the first receiving component comprises: a first receiving element, which is configured to receive the in-dialog SIP message carrying the second index information from the called party.

According to an embodiment of the disclosure, the positioning component comprises: a first acquiring element, which is configured to acquire the second index information from the in-dialog SIP message; and a First positioning element, which is configured to position the current dialog according to the second index information.

According to an embodiment of the disclosure, the SIP UA further comprises: a second receiving component, which is configured to, based on that the SIP UA is the called party of the dialog, receive the initial message from the calling party; and a second transmissing component, which is configured to transmit a response message carrying third index information to the calling party, wherein the third index information is used for indicating the position of the current dialog at the called party.

According to an embodiment of the disclosure, the first receiving component comprises: a second receiving element, which is configured to receive the in-dialog SIP message carrying the third index information from the calling party.

According to an embodiment of the disclosure, the positioning component comprises: a second acquiring element, which is configured to acquire the third index information from the in-dialog SIP message; and a second positioning element, which is configured to position the current dialog according to the third index information.

According to an embodiment of the disclosure, the index information is carried by one of the following fields: Request-uri, contact, from and to.

According to the disclosure, the index information for indicating the position of the dialog at the calling party or the called party is carried by the in-dialog SIP message, and the dialog is positioned according to the index information, so that such an implementation mode is simple and high in positioning speed, and the performance of the network element is improved.

### BRIEF DESCRIPTION OF THE DRAWINGS

Drawings, provided for further understanding of the disclosure and forming a part of the specification, are used to explain the disclosure together with embodiments of the disclosure rather than to limit the disclosure. In the accompanying drawings:

FIG. 1 is a flowchart of a method for positioning a SIP dialog according to an embodiment of the disclosure;

FIG. 2 is a schematic diagram of a basic calling flow of a SIP proxy according to preferred embodiment 1 of the disclosure;

FIG. 3 is a schematic diagram of implementation of a flow when an SIP UA is a calling party in a contact-uri way according to preferred embodiment 2 of the disclosure;

FIG. 4 is a schematic diagram of implementation of a flow when an SIP UA is a called party in a contact-uri way according to preferred embodiment 2 of the disclosure;

FIG. 5 is a schematic diagram of implementation of a flow when an SIP UA is a calling party in a Local-Tag way according to preferred embodiment 3 of the disclosure;

FIG. 6 is a schematic diagram of implementation of a flow when an SIP UA is a called party in a Local-Tag way according to preferred embodiment 3 of the disclosure;

FIG. 7 is a structural diagram of a SIP dialog positioning device according to an embodiment of the disclosure;

FIG. 8 is a structural diagram of a SIP proxy according to an embodiment of the disclosure;

FIG. 9 is a structural diagram of a SIP proxy according to a preferred embodiment of the disclosure;

FIG. 10 is a structural diagram of an SIP UA according to an embodiment of the disclosure; and

FIG. 11 is a structural diagram of an SIP UA according to a preferred embodiment of the disclosure.

### DETAILED DESCRIPTION OF THE EMBODIMENTS

It should be noted that the embodiments of the disclosure and the characteristics in the embodiments can be combined if there is no conflict. The disclosure is described below with reference to the drawings and the embodiments in detail.

A method for positioning a SIP dialog is provided in the embodiment of the disclosure, FIG. 1 is a flowchart of a method for positioning a SIP dialog according to an embodiment of the disclosure, and as shown in FIG. 1, the method comprises the following steps S102 to S104.

S102, a network element receives an in-dialog SIP message carrying index information, wherein the index information is used for indicating a position of a dialog at a calling party or a called party.

S104, the network element positions the dialog according to the index information.

In the related art, an implementation method for positioning the dialog corresponding to the in-dialog SIP message is more complex and lower in positioning speed. In the embodiment, the index information for indicating the position of the dialog at the calling party or the called party is carried in the in-dialog SIP message, and the dialog is positioned according to the index information, so that such an implementation mode is simple and high in positioning speed, and the performance of the network element is improved.

Two kinds of network element roles are defined in the SIP: a SIP proxy and an SIP UA, and the dialog positioning of the two is respectively introduced below.

(1) the network element is a SIP proxy

Before S102, the method further comprises that: the SIP proxy adds a first index information to an initial message received from the calling party, wherein the first index information is used for indicating the position of the current dialog at the calling party; and the SIP proxy transmits the initial message carrying the first index information to the called party. Thus, the position of the current dialog at the calling party can be acquired.

According to an embodiment of the disclosure, after the SIP proxy transmits the initial message carrying the first index information to the called party, the method further comprises that: the SIP proxy receives a response message carrying the first index information from the called party; the SIP proxy modifies the first index information, wherein a modified first index information is used for indicating the position of the current dialog at the called party; and the SIP proxy transmits the response message carrying the modified first index information to the calling party. Thus, the position of the current dialog at the called party can be acquired.

The first index information or the modified index information will be carried in the subsequent in-dialog SIP message, and S102 comprises that: the SIP proxy receives the in-dialog SIP message carrying the modified first index information from the calling party, or receives the in-dialog SIP message carrying the first index information from the called party.

S104 comprises that: the SIP proxy acquires the modified first index information or the first index information from the in-dialog SIP message; and the SIP proxy positions the dialog according to the modified first index information or the first index information.

(2) The network element is an SIP UA, and there are two conditions, wherein the SIP UA serves as the calling party of the dialog under one condition, and serves as the called party of the dialog under the other condition.

A. the SIP UA is the calling party of the dialog

Before S102, the method further comprises that: the SIP UA transmits an initial message carrying second index information to the called party, wherein the second index information is used for indicating the position of the current dialog at the calling party. Thus, the position of the current dialog at the calling party (namely the SIP UA) can be acquired.

The second index information will be carried in a subsequent in-dialog SIP message, and S102 comprises that: the SIP UA receives the in-dialog SIP message carrying the second index information from the called party.

According to an embodiment of the disclosure, S104 comprises that: the SIP UA acquires the second index information from the in-dialog SIP message; and the SIP UA positions the current dialog according to the second index information.

B. the SIP UA is the called party of the dialog

Before S102, the method further comprises that: the SIP UA receives the initial message from the calling party; and the SIP UA transmits a response message carrying third index information to the calling party, wherein the third index information is used for indicating the position of the current dialog at the called party. Thus, the position of the current dialog at the called party (namely the SIP UA) can be acquired.

The third index information will be carried in a subsequent in-dialog SIP message, and S102 comprises that: the SIP UA receives the in-dialog SIP message carrying the third index information from the calling party.

According to an embodiment of the disclosure, S104 comprises that: the SIP UA acquires the third index information from the in-dialog SIP message; and the SIP UA positions the current dialog according to the third index information.

According to an embodiment of the disclosure, the index information is carried by one of the following fields: Request-uri, contact, from, to, Route and Record-Route.

From the above, a header parameter in the SIP message is expanded in the embodiment of the disclosure, and the network element generates the parameter when structuring an initial request or a response to the initial request. The parameter is returned through an in-dialog request received by the network element, and the network element directly positions the dialog through the expanded parameter in the returned in-dialog request. For a subsequent request in the in-dialog, It is not required to position the dialog by virtue of a combination of parameters such as a Call-ID, a From-Tag, a To-Tag, etc in the embodiment of the disclosure, and a dialog index can be directly acquired from the SIP message, so that high speed and high performance are achieved.

Two network element roles are defined in SIP: a proxy and a UA, and for different network element roles, specific implementation schemes are different, and are respectively described below:

For a proxy network element, it is specified in a basic protocol RFC 3261 of SIP that when the proxy network element receives a creating dialog request, if a dialog created according to the request is expected to be reserved and a subsequent request still will pass through the proxy network element, the proxy network element must add a Record-Route header field value to this copy (namely the message forwarded to the next network element), and the added header field value should be before other existing Record-Route header fields. In the subsequent request in the dialog created according to the request, the Record-Route header field value added by the proxy network element can be returned through a Route header. By virtue of the above-mentioned mechanism, a newly added parameter is expanded in Record-Route, and an instance index created for the dialog on the proxy network element is carried in the parameter, so that the proxy network element can directly acquire the corresponding dialog instance index from Route after receiving the subsequent request.

For a UA network element, two schemes can be considered. Scheme 1, it is specified in the basic protocol RFC 3261 of SIP that a Local-Tag is generated by the UA network element, and is returned as a To-Tag in a subsequent request, so that a generation rule of the Local-Tag is changed, wherein a dialog index information is carried in the Local-Tag, and the SIP UA, when receiving the in-dialog request message, acquires the dialog index information from the To-Tag to position the dialog; and scheme 2, according to the basic protocol RFC 3261 of SIP, local-contact-uri is generated by the UA network element, and is returned as Request-uri in the subsequent request, so that an expanded parameter is added in contact-uri, wherein the dialog index information is carried in the expanded parameter, and the SIP UA, when receiving the in-dialog request message, positions the dialog by virtue of the newly added parameter in Request-uri.

It is noted that the dialog index information is carried in the SIP message, and a SIP field capable of carrying the index information includes Request-uri/contact/from/to/route/record-route.

Detailed description will be given below with reference to the preferred embodiments.

### PREFERRED EMBODIMENT 1

The specific implementation of expanded parameter added by the proxy network element through Record-Route/Route is described in the preferred embodiment.

A Backus-Naur Form (BNF) about a Record-Route/Route header in RFC 3261 is as follows:

Record-Route=“Record-Route” HCOLON rec-route *(COMMA rec-route)

rec-route=name-addr *(SEMI rr-param)

rr-param=generic-param

Route=“Route” HCOLON route-param *(COMMA route-param)

route-param=name-addr *(SEMI rr-param)

An rr-param parameter is expanded in the preferred embodiment. The definition of the expanded parameter is related to the specific implementation, and an expansion example under one implementation mode is given here only:

x-did-param=“x-did” EQUAL module “−” dialog-index

module=1*DIGIT

;the number of a module where the dialog is
dialog-index=1*DIGIT

;dialog index

It should be noted that, in order to improve the reliability, x-did-param expansion can also be implemented in name-adds, for example:

Record-Route: <sip:proxy.com;lr >;x-did=1-12

Route: <sip:proxy.com;lr>;x-did=1-12

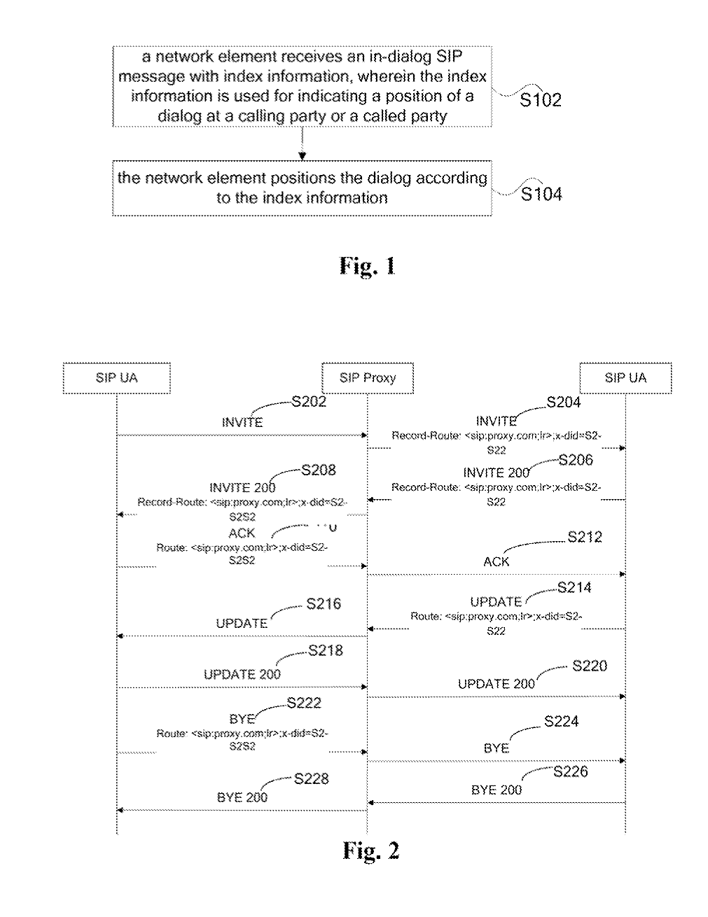

Description will be given blow with reference to FIG. 2, FIG. 2 is a schematic diagram of a basic calling flow of a SIP proxy according to preferred embodiment 1 of the disclosure, and as shown in FIG. 2, the flow includes the following steps that:

S202-S204, the SIP proxy receives initial INVITE, creates an incoming dialog and an outgoing dialog, forwards the INVITE to the next network element, and in order to receive a subsequent request, the SIP Proxy adds itself as Record-Route in the forwarded INVITE. In the preferred embodiment, an expanded parameter x-did is added to a header, wherein the parameter represents a corresponding dialog index of a call on the proxy network element, and in FIG. 2, x-did=1-12, which shows that the corresponding outgoing dialog is on a module 1 and the index is 12.

S206-S208, the SIP proxy receives initial INVITE 200, wherein a route set information is carried in this message, the SIP proxy modifies the Record-Route added itself in the forwarded INVITE 200, and modifies the expanded parameter x-did into an incoming dialog index, and in FIG. 2, x-did=1-11, which shows that the corresponding incoming dialog is on the module 1 and the index is 11.

S210-S212, the SIP proxy receives ACK, where the route set information is carried in this message, and the SIP proxy acquires a dialog index of a dialog where the message is through the expanded parameter x-did in top-Route. In FIG. 2, x-did=1-11, which shows that the corresponding incoming dialog is on the module 1 and the index is 11. The SIP proxy forwards the ACK.

S214-S216, the SIP proxy receives UPDATE from a called side, wherein the route set information is carried in the message. The SIP proxy acquires a dialog index of a dialog where the message is through the expanded parameter x-did in top-Route. In FIG. 2, x-did=1-11, which shows that the corresponding incoming dialog is on the module 1 and the index is 11. The SIP proxy forwards the UPDATE.

S218-S220, the SIP proxy forwards the UPDATE.

S222-S224, the SIP proxy receives BYE from a calling side, the route set information is carried in the message. The SIP proxy acquires a dialog index of a dialog where the message is through the expanded parameter x-did in top-Route. In FIG. 2, x-did=1-11, which shows that the corresponding incoming dialog is on the module 1 and the index is 11. The SIP proxy forwards the BYE (ending).

S226-S228, the SIP proxy forwards BYE 200 OK.

### PREFERRED EMBODIMENT 2

The specific implementation of expanded parameter added by the UA network element through contact-uri is described in the preferred embodiment.

An expanded parameter is added in contact-uri in the preferred embodiment. The definition of the expanded parameter is related to the specific implementation, and an expansion example under one implementation mode is given here only:

x-did-param=“x-did” EQUAL module “−” dialog-index

module=1*DIGIT

;the number of a module where the dialog is

dialog-index=1*DIGIT
;dialog index

For example:

contact: <sip:bod@ua.com;x-did=1-1>

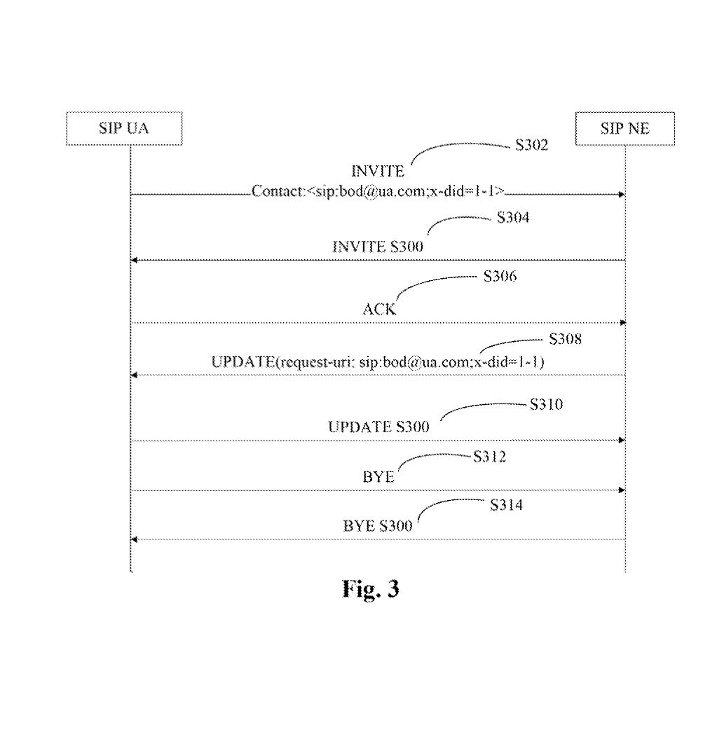

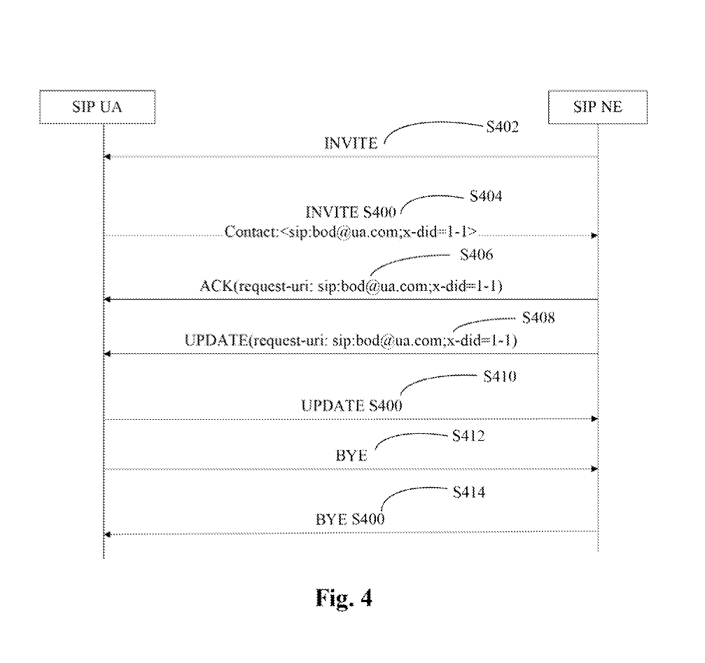

Description will be given below with reference to FIG. 3 and FIG. 4.

FIG. 3 is a schematic diagram of implementation of a flow when an SIP UA is a calling party in a contact-uri way according to preferred embodiment 2 of the disclosure, and as shown in FIG. 3, the flow includes the following steps that:

S302, the SIP UA, serving as the calling party, transmits an initial INVITE message to a next-hop network element (namely the SIP NE shown in FIG. 3), wherein, in a Contact header in the initial INVITE message, an expanded parameter x-did is added in contact-uri, wherein the parameter represents a dialog index of a call on the UA network element, and in FIG. 3, x-did=1-1, which shows that a dialog corresponding to the call is on a module 1 and the index is 1.

S304-S306, subsequent INVITE 200 OK and ACK thereof are processed, which are uninvolved in the preferred embodiment.

S306, the SIP UA receives an in-dialog request UPDATE from a called party, wherein a request-uri content in the request is consistent with a contact-uri content in the initial request INVITE. The SIP UA acquires the dialog index of a dialog where the call is through the expanded parameter x-did in the request-uri. In FIG. 3, x-did=1-1, which shows that the corresponding dialog is on the module 1 and the index is 1.

S310-S314, a subsequent message is processed, which is uninvolved in the preferred embodiment.

FIG. 4 is a schematic diagram of implementation of a flow when an SIP UA is a called party in a contact-uri way according to preferred embodiment 2 of the disclosure, and as shown in FIG. 4, the flow includes the following steps that:

S402, the SIP UA, serving as the called party, receives an initial INVITE message.

S404, the SIP UA returns 200 OK in response to the initial INVITE message, wherein, in a Contact header of the response message, an expanded parameter x-did is added in contact-uri. The parameter represents a dialog index of a call on the UA network element, and in FIG. 4, x-did=1-1, which shows that a dialog corresponding to the call is on a module 1 and the index is 1.

S406, the SIP UA receives an in-dialog request ACK from a calling party, wherein a request-uri content in the request is consistent with a contact-uri content in the 200 OK of the initial INVITE message. The SIP UA acquires the dialog index of a dialog where the call is through the expanded parameter in request-uri. In FIG. 4, x-did=1-1, which shows that the corresponding dialog is on the module 1 and the index is 1.

S408, the SIP UA receives an in-dialog request UPDATE from the calling party, wherein a request-uri content in the request is consistent with a contact-uri content in the 200 OK of the initial INVITE message. The SIP UA acquires the dialog index of the dialog where the call is through the expanded parameter x-did in request-uri. In FIG. 4, x-did=1-1, which shows that the corresponding dialog is on the module 1 and the index is 1.

S410-S414, a subsequent message is processed, which is uninvolved in the preferred embodiment.

### PREFERRED EMBODIMENT 3

The specific implementation of expanded parameter added by the UA network element through the Local-Tag is described in the preferred embodiment.

A BNF about a From/To header in RFC 3261 is as follows:

From=(“From”/“f”) HCOLON from-spec

from-spec=(name-addr/addr-spec)
*(SEMI from-param)

from-param tag-param/generic-param

tag-param=“tag” EQUAL token

To=(“To”/“t”) HCOLON name-addr
/addr-spec) *(SEMI to-param)

to-param=tag-param/generic-param

token=1*(alphanum/“−”/“.”/“!”/“%”
/“_”/“+”/“`”/“′”/“˜”)

A tag-param parameter generated by the network element is limited in the preferred embodiment to enable the dialog index information is carried in the tag-param parameter, and an expansion example under one implementation mode is given here only:

tag-param=“tag” EQUAL randstr “−” module “−” dialog-index

randstr=1*(alphanum)

module=1*DIGIT

;the number of a module where the dialog is

dialog-index=1*DIGIT

;dialog index

For example:

From: <sip:alice@ua.com>;tag=abxcd-1-1

To: <sip:alice@ua.com>;tag=abxcd-1-1

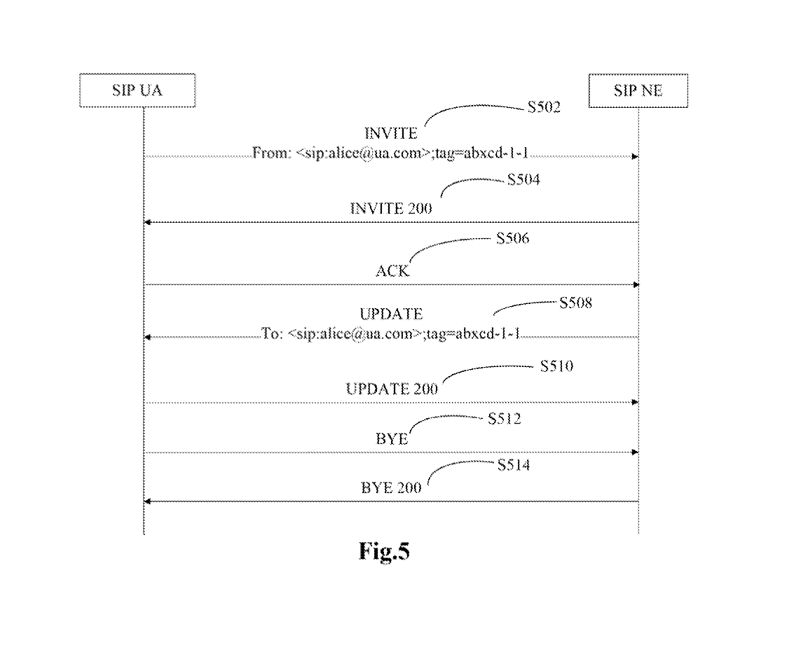

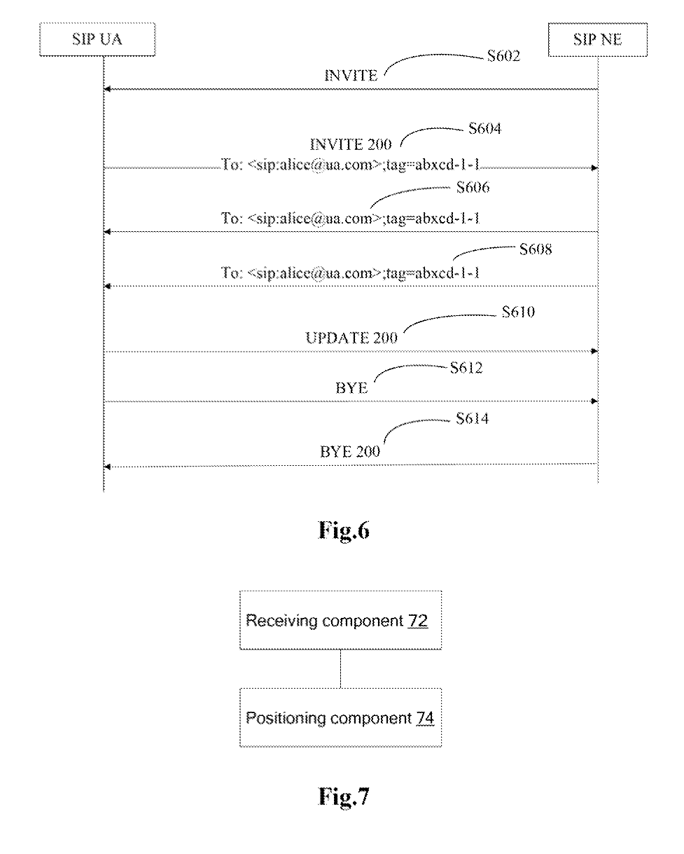

Description will be given blow with reference to FIG. 5 and FIG. 6.

FIG. 5 is a schematic diagram of implementation of a flow when an SIP UA is a calling party in a Local-Tag way according to preferred embodiment 3 of the disclosure, and as shown in FIG. 5, the flow includes the following steps that:

S502, the SIP UA, serving as the calling party, transmits an initial INVITE request to a next-hop network element, wherein a From-Tag in the INVITE request is generated according to the above-mentioned grammar, and the dialog index information is carried in the From-Tag, and in FIG. 5, tag=abxcd-1-1, which shows that a dialog corresponding to a call is on a module 1 and an index is 1.

S504-S506, subsequent INVITE 200 OK and ACK thereof are processed, which are uninvolved in the preferred embodiment.

S508, the SIP UA receives an in-dialog request UPDATE from a called party, wherein a To-Tag content in the request is consistent with the From-Tag in the initial INVITE request. The SIP UA acquires a dialog index of the dialog where the call is from the To-Tag of UPDATE. In FIG. 5, tag=abxcd-1-1, which shows that the corresponding dialog is on the module 1 and the index is 1.

S510-S514, a subsequent message is processed which is uninvolved in the preferred embodiment.

FIG. 6 is a schematic diagram of implementation of a flow when an SIP UA is a called party in a Local-Tag way according to preferred embodiment 3 of the disclosure, and as shown in FIG. 6, the flow includes the following steps that:

S602, the SIP UA, serving as the called party, receives an initial INVITE message.

S604, the SIP UA returns 200 OK in response to the initial INVITE message, wherein a To-Tag of the response message is generated according to the above-mentioned grammar, and dialog index information is carried by the To-Tag, and in FIG. 6, tag=abxcd-1-1, which shows that a dialog corresponding to a call is on a module 1 and an index is 1.

S606, the SIP UA receives an in-dialog request ACK from a calling party, wherein a request-uri content in the request is consistent with a To-Tag content in the 200 OK of the initial INVITE message. The SIP UA acquires a dialog index of a dialog where the call is from the To-Tag. In FIG. 6, x-did=1-1, which shows that the corresponding dialog is on the module 1 and the index is 1.

S608, the SIP UA receives an in-dialog request UPDATE from the calling party, wherein a To-Tag content in the request is consistent with that in the 200 OK of the initial INVITE message, The SIP UA acquires the dialog index of the dialog where the call is from the To-Tag. In FIG. 6, x-did=1-1, which shows that the corresponding dialog is on the module 1 and the index is 1.

S610-S614, a subsequent message is processed, which is uninvolved in the disclosure.

It is noted that the steps shown in the flowcharts in the drawings can be executed in a computer system, for example, a group of computers, capable of executing an instruction, and moreover, although a logic sequence is shown in the flowcharts, the shown or described steps can be executed according to a sequence different from the logic sequence under a certain condition.

A SIP dialog positioning device is further provided in the embodiment of the disclosure, which is applied to a network element. FIG. 7 is a structural diagram of a device for positioning a SIP dialog according to an embodiment of the disclosure, and as shown in FIG. 7, the device includes a receiving component 72 and a positioning component 74.

Wherein, the receiving component 72 is configured to receive an in-dialog SIP message carrying index information, wherein the index information is used for indicating a position of a dialog at a calling party or a called party; and the positioning component 74, connected to the receiving component 72, is configured to position the dialog according to the index information carried by the in-dialog SIP message received by the receiving component 72.

A SIP proxy is further provided in the embodiment of the disclosure, the SIP proxy can be used for implementing the above-mentioned method for positioning a SIP dialog. FIG. 8 is a structural diagram of a SIP proxy according to an embodiment of the disclosure, and as shown in FIG. 8, the SIP proxy includes a first receiving component 82 and a positioning component 84.

Wherein, the first receiving component 82 is configured to receive an in-dialog SIP message carrying index information, wherein the index information is used for indicating a position of a dialog at a calling party or a called party; and the positioning component 84, connected to the first receiving component 82, is configured to position the dialog according to the index information.

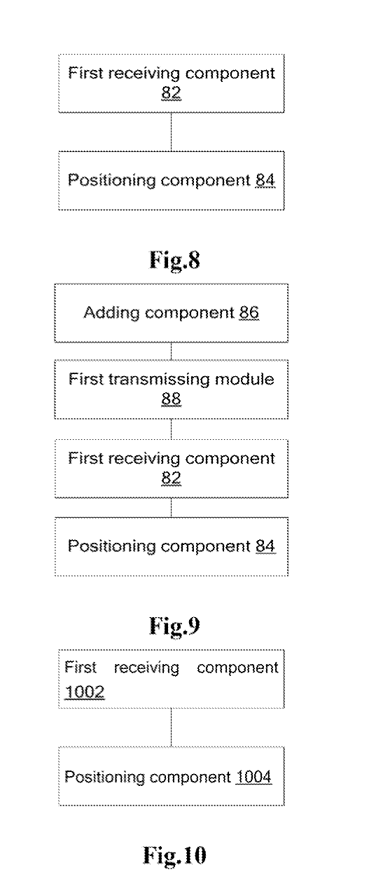

As shown in FIG. 9, the SIP proxy further includes: an adding component 86, which is configured to add a first index information to an initial message received from the calling party, wherein the first index information is used for indicating the position of the current dialog at the calling party; and a first transmissing component 88, which is connected to the adding component 86 and configured to transmit the initial message carrying the first index information to the called party.

According to an embodiment of the disclosure, the SIP proxy further includes: a second receiving component, which is configured to receive a response message carrying the first index information from the called party: a modifying component, which is connected to the second receiving component and configured to modify the first index information, wherein the modified first index information is used for indicating the position of the current dialog at the called party; and a second transmissing component, which is connected to the modifying component and configured to transmit the response message carrying the modified first index information modified by the modifying module to the calling party.

According to an embodiment of the disclosure, the first receiving component 82 includes: a receiving element, which is configured to receive the in-dialog SIP message carrying the modified first index information from the calling party, or receive the in-dialog SIP message carrying the first index information from the called party. The positioning component 84 includes: an acquiring element, which is configured to acquire the modified first index information or the first index information from the in-dialog SIP message: and a positioning element, which is connected to the acquiring element and configured to position the dialog according to the modified first index information or the first index information acquired by the acquiring element.

According to an embodiment of the disclosure, the index information is carried by one of the following fields: Route and Record-Route.

AN SIP UA is further provided in the embodiment of the disclosure. The SIP can be used for implementing the above-mentioned method for positioning a SIP dialog. FIG. 10 is a structural diagram of an SIP UA according to an embodiment of the disclosure, and as shown in FIG. 10, the SIP UA includes a first receiving component 1002 and a positioning component 1004.

Wherein, the first receiving component 1002 is configured to receive an in-dialog SIP message carrying index information, wherein the index information is used for indicating a position of a dialog at a calling party or a called party; and the positioning component 1004, connected to the first receiving component 1002, is configured to position the dialog according to the index information.

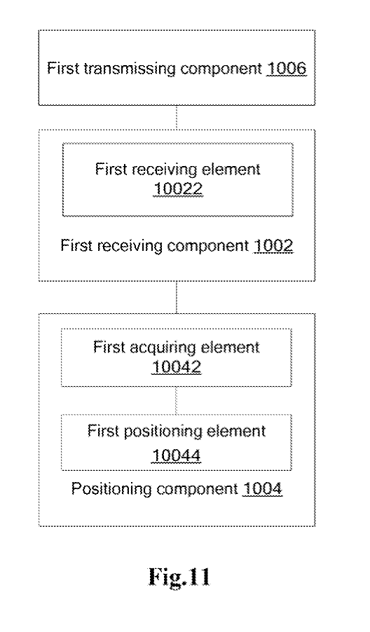

As shown in FIG. 11, the SIP UA further includes: a first transmissing component 1006, which is configured to, under the condition that the SIP UA is the calling party of the dialog, transmit an initial message carrying second index information to the called party, wherein the second index information is used for indicating the position of the current dialog at the calling party. The first receiving component 1002 includes: a first receiving element 10022, which is configured to receive the in-dialog SIP message carrying the second index information from the called party, The positioning component 1004 includes: a first acquiring element 10042, configured to acquire the second index information from the in-dialog SIP message; and a first positioning element 10044, which is connected to the first acquiring element 10042 and configured to position the current dialog according to the second index information acquired by the first acquiring element 10042.

According to an embodiment of the disclosure, the SIP UA further includes: a second receiving component, which is configured to, under the condition that the SIP UA is the called party of the dialog, receive the initial message from the calling party; and a second transmissing component, configured to transmit a response message carrying third index information to the calling party, wherein the third index information is used for indicating the position of the current dialog at the called party.

According to an embodiment of the disclosure, the first receiving component 1002 includes: a second receiving element, which is configured to receive the in-dialog SIP message carrying the third index information from the calling party. The positioning component 1004 includes: a second acquiring element, which is configured to acquire the third index information from the in-dialog SIP message; and a second positioning element, which is configured to position the current dialog according to the third index information.

According to an embodiment of the disclosure, the index information is carried by one of the following fields: Request-uri, contact, from and to.

From the above, according to the embodiments of the disclosure, a method and a device for positioning a SIP dialog are provided. The index information for indicating the position of the dialog at the calling party or the called party is carried in the in-dialog SIP message, and the dialog is positioned according to the index information, so that such an implementation mode is simple and high in positioning speed, and the performance of the network element is improved.

Obviously, a technician of the field should know that each module or step of the disclosure can be implemented by a universal computing device, and the modules or steps can be concentrated on a single computing device or distributed on a network formed by a plurality of computing devices, and can optionally be implemented by programmable codes executable for the computing devices, so that the modules or steps can be stored in a storage device for execution with the computing devices, or can form each integrated circuit module, or multiple modules or steps therein can form a single integrated circuit module for implementation. As a consequence, the disclosure is not limited to any specific hardware and software combination.

The above is only the preferred embodiment of the disclosure and not intended to limit the disclosure, and for the technician of the field, the disclosure can have various modifications and variations. Any modifications, equivalent replacements, improvements and the like within the spirit and principle of the disclosure shall fall within the scope of protection of the disclosure.

1. A method for positioning Session Initiation Protocol (SIP) dialog, comprising:
receiving, by a network element, an in-dialog SIP message carrying index information, wherein the index information is used for indicating a position of a dialog at a calling party or a called party; and
positioning, by the network element, the dialog according to the index information.

2. The method according to claim 1, wherein based on that the network element is an SIP proxy, before receiving, by the network element, the in-dialog SIP message carrying the index information, further comprising:
adding, by the SIP proxy, a first index information to an initial message received from the calling party, wherein the first index information is used for indicating the position of the current dialog at the calling party; and
transmitting, by the SIP proxy, the initial message carrying the first index information to the called party.

3. The method according to claim 2, wherein after transmitting, by the SIP proxy, the initial message carrying the first index information to the called party, further comprising:
receiving, by the SIP proxy, a response message carrying the first index information from the called party;
modifying, by the SIP proxy, the first index information, wherein a modified first index information is used for indicating the position of the current dialog at the called party; and
transmitting, by the SIP proxy, the response message carrying the modified first index information to the calling party.

4. The method according to claim 3, Wherein receiving, by the network element, the in-dialog SIP message carrying the index information comprises:
receiving, by the SIP proxy, the in-dialog SIP message carrying the modified first index information from the calling party, or receiving, by the SIP proxy, the in-dialog SIP message carrying the first index information from the called party.

5. The method according to claim 4, wherein positioning, by the network element, the dialog according to the index information comprises:
acquiring, by the SIP proxy, the modified first index information or the first index information from the in-dialog SIP message; and
positioning, by the SIP proxy, the dialog according to the modified first index information or the first index information.

6. The method according to claim 1, wherein based on that the network element is an SIP User Agent (UA) and is the calling party of the dialog, before receiving, by the network element, the in-dialog SIP message carrying the index information, further comprising:
transmitting, by the SIP UA, an initial message carrying second index information to the called party, wherein the second index information is used for indicating the position of the current dialog at the calling party.

7. The method according to claim 6, wherein receiving, by the network element, the in-dialog SIP message carrying the index information comprises:
receiving, by the SIP UA, the in-dialog SIP message carrying the second index information from the called party;
positioning, by the network element, the dialog according to the index information comprises: acquiring, by the SIP UA, the second index information from the in-dialog SIP message; and positioning, by the SIP UA, the current dialog according to the second index information.

8. (canceled)

9. The method according to claim 1, wherein based on that the network element is an SIP UA and is the called party of the dialog, before receiving, by the network element, the in-dialog SIP message carrying the index information, further comprising:
receiving, by the SIP UA, the initial message from the calling party; and
transmitting, by the SIP UA, a response message carrying third index information to the calling party, wherein the third index information is used for indicating the position of the current dialog at the called party.

10. the method according to claim 9, wherein receiving, by the network element, the in-dialog SIP message carrying the index information comprises:
receiving, by the SIP UA, the in-dialog SIP message carrying the third index information from the calling party;
positioning, by the network element, the dialog according to the index information comprises: acquiring, by the SIP UA, the third index information from the in-dialog SIP message; and positioning, by the SIP UA, the current dialog according to the third index information.

11. (canceled)

12. The method according to claim 1, wherein the index information is carried by one of the following fields: Request-uri, contact, from, to, Route and Record-Route.

13. A device for positioning Session Initiation Protocol (SIP) dialog, applied to a network element, comprising:
a receiving component, configured to receive an in-dialog SIP message carrying index information, wherein the index information is used for indicating a position of a dialog at a calling party or a called party; and
a positioning component, configured to position the dialog according to the index information.

14. (canceled)

15. The device according to claim 13, further comprising:
an adding component, configured to, based on that the network element is a Session Initiation Protocol (SIP) proxy, add a first index information to an initial message received from the calling party, wherein the first index information is used for indicating the position of the current dialog at the calling party; and
a first transmissing component, configured to transmit the initial message carrying the first index information to the called party.

16. The device according to claim 15, further comprising:
a second receiving component, configured to receive a response message carrying the first index information from the called party;
a modifying component, configured to modify the first index information, wherein a modified first index information is used for indicating the position of the current dialog at the called party; and
a second transmissing component, configured to transmit the response message carrying the modified first index information to the calling party.

17. The device according to claim 16, wherein the first receiving component comprises:
a receiving element, configured to receive the in-dialog SIP message carrying the modified first index information from the calling party, or receive the in-dialog SIP message carrying the first index information from the called party.

18. The device according to claim 17, wherein the positioning component comprises:
an acquiring element, configured to acquire the modified first index information or the first index information from the in-dialog SIP message; and
a positioning element, configured to position the dialog according to the modified first index information or the first index information.

19. (canceled)

20. (canceled)

21. The device according to claim 13, further comprising:
a first transmissing component, configured to, based on that the network element is a Session Initiation Protocol (SIP) User Agent (UA) and the SIP UA is the calling party of the dialog, transmit an initial message carrying second index information to the called party, wherein the second index information is used for indicating the position of the current dialog at the calling party.

22. The device according to claim 21, wherein the first receiving component comprises:
a first receiving element, configured to receive the in-dialog SIP message carrying the second index information from the called party;
the positioning component comprises: a first acquiring element, configured to acquire the second index information from the in-dialog SIP message, and a first positioning element, configured to position the current dialog according to the second index information.

23. (canceled)

24. The device according to claim 13, further comprising:
a second receiving component, configured to, based on that the network element is a Session Initiation Protocol (SIP) User Agent (UA) and the SIP UA is the called party of the dialog, receive the initial message from the calling party; and
a second transmissing component, configured to transmit a response message carrying third index information to the calling party, wherein the third index information is used for indicating the position of the current dialog at the called party.

25. The device according to claim 24, wherein the first receiving component comprises:
a second receiving element, configured to receive the in-dialog SIP message carrying the third index information from the calling party;
the positioning component comprises: a second acquiring element, configured to acquire the third index information from the in-dialog SIP message; and a second positioning element, configured to position the current dialog according to the third index information.

26. (canceled)

27. The device according to claim 13, wherein the index information is carried by one of the following fields: Request-uri, contact, from, to, Route and Record-Route.
